(19) United States
(12) Patent Application Publication
(10) Pub. No.: US 2023/0150147 A1
(43) Pub. Date: May 18, 2023

(54) CLAMP APPARATUS AND TRANSPORT APPARATUS

(71) Applicant: KRONES AG, Neutraubling (DE)

(72) Inventor: Marco LEIDEL, Rain (DE)

(21) Appl. No.: 17/985,465

(22) Filed: Nov. 11, 2022

(30) Foreign Application Priority Data
Nov. 12, 2021 (DE) DE102021129518.1

(51) Int. Cl. B25J 15/10

(52) U.S. Cl. CPC B25J 15/10

(57) ABSTRACT

The invention relates inter alia to a clamp apparatus for retaining a container for a container treatment installation. A first clamp arm pair and a second clamp arm pair are arranged one above the other in order to simultaneously retain the container. A first drive unit is in order to actuate the first clamp arm pair operationally connected to the first clamp arm pair, and a second drive unit is in order to actuate the second clamp arm pair operationally connected to the second clamp arm pair. Advantageously, the clamp apparatus may, for example, be particularly flexible and structural-space-saving.

### CROSS REFERENCE TO RELATED APPLICATIONS

This application claims the benefit under 35 U.S.C. § 119(a) of German Patent Application No. DE 10 2021 129 518.1 filed Nov. 12, 2021 entitled CLAMP APPARATUS AND TRANSPORT APPARATUS, and whose entire disclosure is incorporated by reference herein.

### TECHNICAL FIELD

The invention relates to a clamp apparatus for retaining a container and a transport apparatus for transporting containers.

### TECHNICAL BACKGROUND

In container treatment installations for cleaning, filling, closing, etcetera, containers, containers can be retained by means of gripper or clamp apparatuses and transported through the installation.

Generally, multifunctional fittings in the form of clamping starwheels for container transport in container treatment installations are mechanically actuated. This actuation is carried out, for example, by means of rollers which are controlled by means of curves. A cam control is also possible. Furthermore, in order to generate the retention force for container locking, resilient elements are generally required. These may, for example, be integrated in the clamp apparatuses themselves or be configured by means of separate springs.

Disadvantages of the conventional technology may, for example, involve mechanical components which are fitted to a rotating axle (rotary apparatus) being subjected to extreme wear. This wear originates from the actuation mechanism of the respective variant. Furthermore, the force for generating the retention force is configured once by the predefined resilient element and cannot be varied without replacing a component. The variation requires costly retrofitting. With conventional solutions, no different diameters can also be gripped on containers. Containers which are recessed, protruding, conical, etcetera, can only be retained with significant complexity or not at all by multi-fittings in the non-cylindrical region. Consequently, contoured bottles are gripped very near the bottom or deliberate gripping errors are accepted, which has significant effects on product quality and process reliability.

DE 10 2014 005 321 A1 discloses a transport apparatus for transporting and treating containers, wherein the containers are transported by the transport apparatus in a transport direction from an input location to an output location. The transport apparatus has at least one handling device which moves in the transport direction for handling one or more of the containers. The transport device has at least one motor by means of which the at least one handling device can be moved in a motorised manner in a direction different from the transport direction.

An object of the invention is to provide an improved technology for retaining containers which is preferably particularly variable, only subjected to a low level of wear and/or enables containers whose covering faces are shaped/sized differently to be held in an operationally reliable and nondamaging manner.

### SUMMARY OF INVENTION

The object is achieved by the features of the independent claim 1. Advantageous developments are set out in the dependent claims and the description.

One aspect of the present disclosure relates to a clamp apparatus for retaining a container for a container treatment installation. The clamp apparatus has a first clamp arm pair and a second clamp arm pair which are arranged one above the other for the simultaneous retention of the container (for example, on two levels). The clamp apparatus has a first drive unit which in order to actuate (for example, open and/or close) the first clamp arm pair is operationally connected to the first clamp arm pair. The clamp apparatus has a second drive unit which in order to actuate (for example, open and/or close) the second clamp arm pair is operationally connected to the second clamp arm pair (for example, independently of the first drive unit and/or the operational connection between the first drive unit and the second drive unit).

Advantageously, the two drive units enable the clamp arm pairs to be able to be opened and closed at any desired location or at any desired time. This advantage can optimise the transfer of the containers. No further compromises have to be made as a result of control elements which have been adjusted once. Each container can be adjusted in an optimal manner to the radially best transfer location thereof in accordance with the container format. A specific function of the container transport, such as, for example, the selective container discharge and the distribution of the containers to different connection stations, can also be carried out in a very simple manner. The retention force with which the container is retained can be varied in a simple manner. For example, depending on weight, size and diameter, a freely selectable value can be determined with respect to the retention force. A protective container handling and a reduced machine wear can be achieved. In addition, a loading of the drive (torque, power consumption, position errors, etcetera) which moves the transport apparatus to which the clamp apparatus is fixed, can be significantly reduced since no mechanical control also has to be driven by means of rollers or cams. Only the inertia moment from the mass of the transport apparatus itself has to be overcome. Advantageously, there is also produced a very hygienic embodiment since, for example, resilient elements can be dispensed with if desired and fewer difficult-toaccess locations (for example, cracks) for colonies of bacteria are present. Preferably, a very significant component minimisation and resultant complexity minimisation can also be produced since, for example, rollers, switching rods, sliding films, roller axles and/or springs are no longer required. On the whole, with the improved clamp apparatus a technical improvement towards high-end equipment can be achieved. Finally, it should also be mentioned that the clamp apparatus enables contoured containers (contour containers) to be gripped and retained securely in a very simple manner.

In one embodiment, the first drive unit and the second drive unit can be controlled independently of each other, preferably pneumatically. Alternatively or additionally, the first clamp arm pair can be actuated by means of the first drive unit and the second clamp arm pair can be actuated by means of the second drive unit independently of each other. Advantageously, an independent movement of the clamp arm pairs can thereby be enabled, which, for example, can be used for reliable and low-wear transportation of contoured containers.

In another embodiment, at least one from the first drive unit and the second drive unit is a pneumatic drive unit, preferably a pneumatic actuator. Advantageously, a simple and reliable implementation of the drive units which is favourable in terms of structural space can be enabled.

In another embodiment, a retention force, an opening time, a closure time and/or an adjustment path of the first clamp arm pair by means of the first drive unit and/or of the second clamp arm pair by means of the second drive unit can be adjusted in a variable manner, preferably pneumatically. Advantageously, therefore, for example, without retrofitting during operation or during an operational break, the retention force, the opening time, the closure time and/or the adjustment path of the first clamp arm pair and/or the second clamp arm pair can be adjusted. Advantageously, for example, it is consequently possible to optimise a transfer and a retention of the containers in accordance with the container format. Generally, a fully flexible operation of the clamp apparatus can be enabled.

In another embodiment, the clamp apparatus has a (for example, pneumatic) control unit for controlling the first drive unit and/or the second drive unit. Preferably, the control unit may be configured to operate at least one from the first drive unit and the second drive unit in different modes. Advantageously, the different modes may replace the generally necessary complex retrofitting, etcetera, and consequently on the whole enable an increased capacity and promote flexible operation.

Preferably, the term “control unit” may relate to a pneumatic control (for example, with pneumatic (for example proportional) valve(s) which can be controlled, for example, pneumatically). The “control unit” may perform control functions and/or regulation functions and/or processing functions depending on the construction. Even if the term “control” is used herein, so to speak “regulating” or “controlling with feedback” and/or “processing” may advantageously also be included or meant thereby.

In one embodiment, the different modes differ at least partially with respect to a retention force, an opening time, a closure time and/or an adjustment path of the respective clamp arm pair. Advantageously, the different modes may, for example, enable predetermined functions of the container transport, such as, for example, the transportation of different containers, a selective discharge of specific containers and/or the distribution of the containers to different connection stations.

In another embodiment, the different modes are configured for retaining different containers, wherein the different containers differ, preferably with respect to a container weight, a container size, a container shape, a container diameter and/or a container material.

In one embodiment, the operational connection between the first drive unit and the first clamp arm pair, the operational connection between the second drive unit and the second clamp arm pair, the first drive unit and/or the second drive unit is/are formed without a resilient spring element. Advantageously, therefore, a structurally simple and hygienic embodiment of the clamp apparatus can be enabled since it is possible to dispense with resilient elements.

In another variant, the clamp apparatus further has a, preferably substantially block-shaped and/or elongate, clamp carrier which carries the first clamp arm pair and/or the second clamp arm pair in a movable, preferably displaceable or pivotable, manner, in a particularly preferred manner at mutually opposing end regions of the clamp carrier (for example, at an upper end region and at a lower end region of the clamp carrier).

Preferably, the clamp carrier may be orientated in an upright manner.

In another variant, at least one from the first drive unit and the second drive unit is carried by the clamp carrier, preferably at a rear side of the clamp carrier which is opposite a front side of the clamp carrier facing the container which can be retained by the first clamp arm pair and the second clamp arm pair. Advantageously, at least one from the first drive unit and the second drive unit may be arranged on the rear side of the clamp carrier in such a manner that the first drive unit and/or the second drive unit is protected from container fragments by the clamp carrier in the event of container breakage of a container retained by the first clamp arm pair and the second clamp arm pair.

Preferably, the first clamp arm pair and the second clamp arm pair can be moved, preferably displaced or pivoted, independently of each other (for example, coaxially).

Preferably, the first clamp arm pair and the second clamp arm pair are constructed in a structurally identical and/or substantially mirror-symmetrical manner with respect to a horizontal plane.

For example, the first drive unit and the second drive unit can be arranged one above the other, in a structurally identical manner, substantially in a mirror-symmetrical manner with respect to a horizontal plane and/or be carried by a clamp carrier of the clamp apparatus.

Preferably, the first drive unit and/or the second drive unit may have a displaceable output element.

In a particularly preferred manner, a linear forward feed movement and backward feed movement of the output element of the first drive unit can be converted by a toggle joint into a pivot movement of the first clamp arm pair.

Alternatively or additionally, a linear forward feed and backward feed movement of the output element of the second drive unit can be converted by means of a toggle joint into a pivot movement of the second clamp arm pair.

It is possible for an output element of the first drive unit and/or a transfer element which is connected to the output element to extend in a displaceable manner through a clamp carrier of the clamp apparatus. Alternatively or additionally, an output element of the second drive unit and/or a transfer element which is connected to the output element may extend in a displaceable manner through a clamp carrier of the clamp apparatus.

In another variant, the first clamp arm pair has two first clamp arms, which are preferably coupled to each other, for abutting the container and which can preferably be moved, preferably pivoted or displaced, in opposing directions relative to each other. Alternatively or additionally, the second clamp arm pair has two second clamp arms, which are preferably coupled to each other, for abutting the container and which can preferably be moved in opposing directions relative to each other (and, for example, independently of the two first clamp arms) and are preferably pivotable or displaceable (for example, coaxially pivotable with respect to the first two clamp arms).

In one embodiment, the clamp apparatus further has two first pivot arms which are arranged in a V-shaped manner and which can be displaced back and forth in response to a mechanical input by means of the first drive unit and/or which are each pivotably fitted to one clamp arm of the first clamp arm pair. Alternatively or additionally, the clamp apparatus further has two second pivot arms which are arranged in a V-shaped manner and which can be displaced back and forth in response to a mechanical input by means of the second drive unit and/or which are each pivotably fitted to one clamp arm of the second clamp arm pair.

In another embodiment, the two first pivot arms are fitted so as to be able to be pivoted, preferably coaxially, to a displaceable first transfer element which is displaceably supported in a clamp carrier of the clamp apparatus, is rod-like and/or can be displaced by the first drive unit. Alternatively or additionally, the two second pivot arms are fitted so as to be able to be pivoted, preferably coaxially, to a displaceable second transfer element which is displaceably supported in a clamp carrier of the clamp apparatus, is rod-like and/or can be displaced by the second drive unit.

Preferably, an output element of the first drive unit can be connected (for example, directly) to the first transfer element, for example, secured to each other or constructed with each other integrally in one piece. Alternatively or additionally, an output element of the second drive unit can be connected (for example, directly) to the second transfer element, for example, secured to each other or constructed with each other integrally in one piece.

Another aspect of the present disclosure relates to a transport apparatus, preferably a rotatable clamp starwheel for containers for a container treatment installation. The transport apparatus has at least one clamp apparatus as disclosed herein. The transport apparatus may further optionally have a rotary distributor which is connected to at least one from the first drive unt and the second drive unit, preferably pneumatically. The transport apparatus may advantageously achieve the same advantages which have already been described for the clamp apparatus.

Preferably, the container treatment installation may be configured to produce, clean, check, fill, close, label, print and/or package containers for liquid media, preferably drinks or liquid foods.

For example, the containers may be in the form of bottles, cans, canisters, cartons, flasks, etcetera.

The above-described preferred embodiments and features of the invention can be freely combined with each other.

### BRIEF DESCRIPTION OF THE FIGURES

Further details and advantages of the invention are described below with reference to the appended drawings, in which:

FIG. 1 shows a perspective view of a clamp apparatus according to an embodiment of the present disclosure;

FIG. 2 shows a sectioned view through the exemplary clamp apparatus of FIG. 1;

FIG. 3 shows a plan view of the exemplary clamp apparatus of FIG. 1;

FIG. 4 shows a perspective view of a transport apparatus according to an embodiment of the present disclosure;

FIG. 5 shows a sectioned view through the exemplary transport apparatus of FIG. 4; and

FIG. 6 shows a view from below of the exemplary transport apparatus of FIG. 4.

The embodiments which are shown in the Figures at least partially correspond so that similar or identical components are indicated with the same reference numerals and reference may also be made for the explanation thereof to the description of the other embodiments or Figures in order to avoid repetition.

### DETAILED DESCRIPTION OF EXEMPLARY EMBODIMENTS

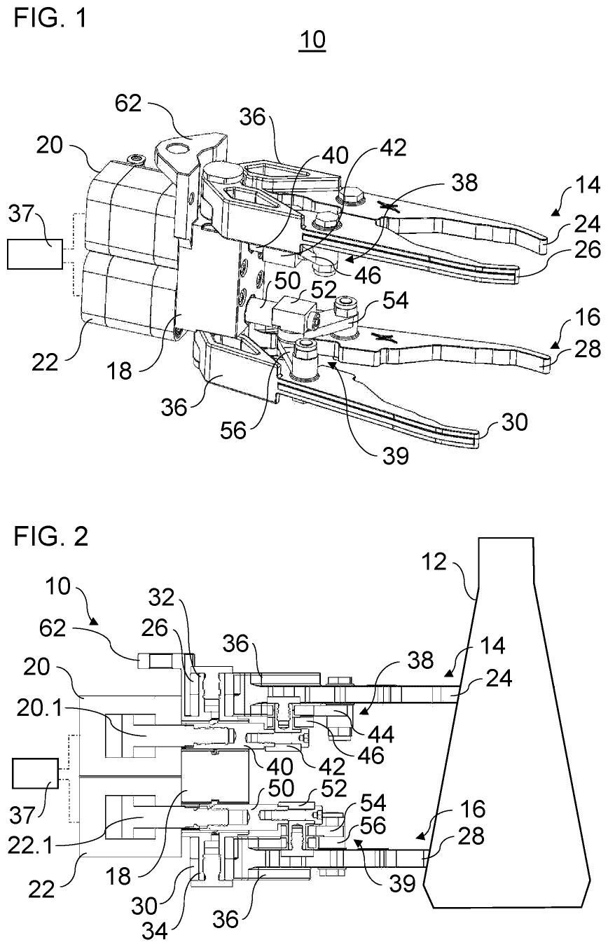

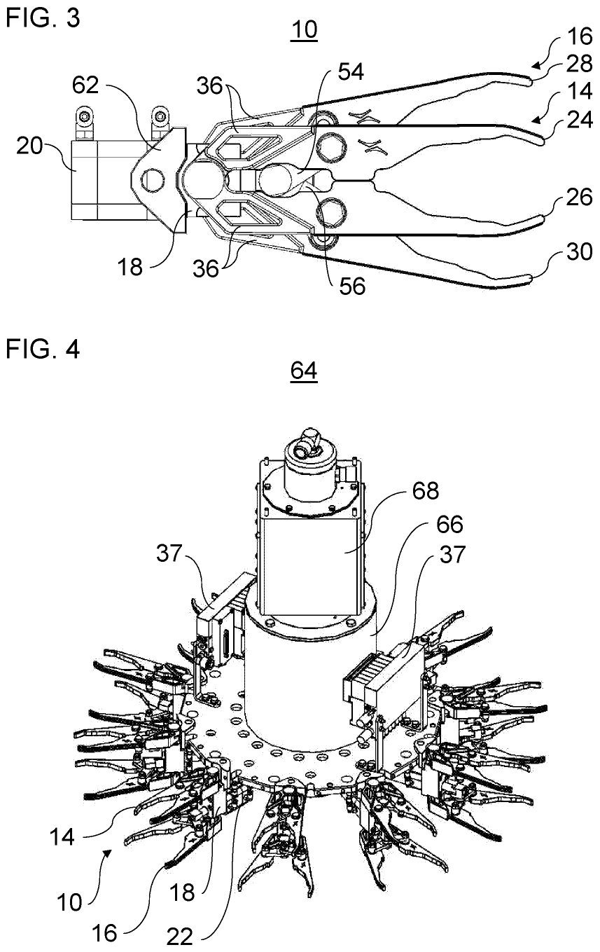

FIGS. 1 to 3 show a clamp apparatus 10 in different views. The clamp apparatus 10 may retain or grip a container 12 (illustrated schematically only in FIG. 2). The container 12 may have a container body with different outer circumferences along the length or height thereof. For example, the container 12 may be in the form of a so-called contour container. It is also possible for the container body of the container 12 to have a different shape, for example, a cylindrical shape.

The clamp apparatus 10 has a first clamp arm pair 14 and a second clamp arm pair 16. The clamp apparatus 10 further has a first drive unit 20, a second drive unit 22 and optionally a clamp carrier 18.

Preferably, the clamp apparatus 10 is in the form of a dual clamp apparatus or a dual-level clamp apparatus having the two clamp arm pairs 14, 16. However, it is also possible for the clamp apparatus to have additional clamp arm pairs (not illustrated). Generally, the clamp apparatus 10 may be in the form of a multiple clamp apparatus or multi-level clamp apparatus having a plurality of clamp arm pairs 14, 16.

The first clamp arm pair 14 may have two first clamp arms 24, 26. The second clamp arm pair 16 may have two second clamp arms 28, 30. The clamp arms 24 and 26 (or 28 and 30) may be constructed separately, as illustrated in FIGS. 1 and 2. It is possible for the clamp arms 24 and 26 (or 28 and 30) to be constructed integrally in one piece with each other. It is also possible for additional clamp arms to be included.

Preferably, the second clamp arm pair 16 may be configured to be substantially structurally identical and/or functionally identical to the first clamp arm pair 14. Preferably the first clamp arm pair 14 and the second clamp arm pair 16 are constructed to be substantially mirror-symmetrical with respect to a longitudinal centre plane of the clamp apparatus 10 or with respect to a horizontal plane (in the assembled state). The longitudinal centre plane divides the clamp apparatus 10 in the middle and may, for example, extend parallel with longitudinal axes or orientation planes of the clamp arm pairs 14, 16.

The clamp arm pairs 14, 16 may each be pivotably supported, as illustrated. The pivotable bearing is preferably arranged at an end of the clamp arm pairs 14, 16 opposite the container 12 or the free ends of the clamp arm pairs 14, 16. The clamp arm pairs 14, 16 may preferably be able to be pivoted coaxially with respect to each other or able to be pivoted about a common pivot axis. However, it is also possible for the clamp arm pairs 14 and/or 16 to be displaceably supported.

In detail, the first clamp arms 24, 26 can preferably be moved, preferably pivoted (as illustrated) or displaced, in opposite directions relative to each other. The second clamp arms 28, 30 can be moved, preferably pivoted (as illustrated) or displaced, in opposite directions relative to each other. In order to retain the container 12, the first clamp arms 24, 26 can be moved (for example pivoted or displaced) with respect to each other until abutting the container 12 and the second clamp arms 28, 30 can be moved (for example, pivoted or displaced) with respect to each other until abutting the container 12. In order to release the container 12, the first clamp arms 24, 26 can be moved (for example, pivoted or displaced) away from each other and the second clamp arms 28, 30 can be moved (for example, pivoted or displaced) away from each other.

The first and second clamp arm pairs 14, 16 are arranged one above the other in order to simultaneously retain the same container 12. The first and second clamp arm pairs 14, 16 are, for example, arranged vertically offset from one another with respect to a vertical axis of the container 12 or the clamp apparatus 10. For example, the first clamp arm pair 14/the two first clamp arms 24, 26 is/are arranged above the second clamp arm pair 16/the two second clamp arms 28, 30, as illustrated in FIGS. 1 to 3, or vice versa.

The first clamp arm pair 14 can retain the container 12 at a first outer circumferential portion or cover portion. The second clamp arm pair 16 can retain the container 12 on a second outer circumferential portion or cover portion. The first and second outer circumferential portion is preferably circumferential in each case or self-contained. The outer circumferential portions are arranged offset from each other with respect to a vertical axis of the container 12. For example, the first outer circumferential portion is arranged above the second outer circumferential portion or vice versa.

It is possible for the first outer circumferential portion and the second outer circumferential portion to differ from each other in terms of shape and/or size or length. In the embodiment illustrated, for example, the shape of the first outer circumferential portion and the second outer circumferential portion is identical, that is to say, circular with respect to a container cross section or frustoconical with respect to the vertical axis of the container. The first and second outer circumferential portions differ in terms of size. The first outer circumferential portion has a smaller circumference and a smaller diameter than the second outer circumferential portion.

The container 12 may be retained in each case on the portions of the clamp arm pairs 14, 16 at the front or facing the container 12. In detail, the container 12 may be retained between the free ends of the first clamp arms 24, 26 and between the free ends of the second clamp arms 28, 30. The first clamp arms 24, 26 and the second clamp arms 28, 30 can engage around the container 12 at the free ends thereof. The first clamp arms 24, 26 and the second clamp arms 28, 30 may clamp the container 12 between the free ends thereof with a retention force being applied. The retention force of the first clamp arm pair 14 may be brought about by the first drive unit 20. The retention force of the second clamp arm pair 16 can be brought about by the second drive unit 22.

The two clamp arm pairs 14, 16 may be able to be moved, preferably pivoted or displaced, independently or decoupled from each other. The first clamp arm pair 14 can be moved (for example, pivoted or displaced) without the second clamp arm pair 16 also moving and vice versa. An abutment pivot movement or abutment displacement movement of the first clamp arm pair 14 against the container 12 may, for example, not influence an abutment pivot movement or abutment displacement movement of the second clamp arm pair 16 against the container 12 and vice versa. The abutment pivot movement or abutment displacement movement of the second clamp arm pair 16 may, for example, continue, whilst the first clamp arm pair 14 is already in abutment against the container and vice versa (for example, depending on a shape and/or size of the outer circumferential portions of the container). For example, the clamp arm pairs 14, 16, preferably under the action of one of the drive units 20 and 22, may simultaneously begin the abutment movement and/or end it one after the other (for example, in each case at the time of abutment against the container 12). During the abutment pivot movement, the respective clamp arms 24, 26 or 28, 30 may pivot towards each other, whereas during the abutment displacement movement the respective clamp arms 24, 26 or 28, 30 can be displaced relative to each other.

A release movement (for example, release pivot movement or release displacement movement) of the second clamp arm pair 16 away from the container 12 can preferably not influence a release pivot movement of the first clamp arm pair 14 away from the container 12 and vice versa. The release movement of the first clamp arm pair 14 may, for example, begin before the release movement of the second clamp arm pair 16 begins and vice versa (for example, depending on a shape and/or size of the outer circumferential portions of the container 12). For example the clamp arm pairs 14, 16, preferably under the action of an actuation of the clamp arm pairs 14, 16 by means of the drive units 20, 22, can terminate the release movement simultaneously. During the release pivot movement, the respective clamp arms 24, 26 or 28, 30 may pivot away from each other, whereas during the release displacement movement the respective clamp arms 24, 26 or 28, 30 can be displaced away from each other.

The clamp arm pairs 14, 16 may in each case have a longitudinal axis. The longitudinal axes may extend substantially parallel with each other. The longitudinal axes may extend substantially perpendicularly to a vertical axis of the clamp apparatus 10 or the container 12. In the assembled state, the longitudinal axes may extend substantially parallel with a horizontal plane.

The clamp arm pairs 14, 16 may be movably, preferably pivotably or displaceably, supported on the clamp carrier 18. The clamp arm pairs 14, 16 may be supported at opposing sides of the clamp carrier 18 on the clamp carrier 18. The clamp carrier 18 may be arranged between the clamp arm pairs 14, 16, preferably with respect to a vertical axis of the clamp apparatus 10. The clamp carrier 18 may carry the clamp arm pairs 14, 16. The clamp carrier 18 is preferably configured in a block-like manner. The clamp carrier 18 extends preferably in an elongate manner parallel with the vertical axis of the container 12 or the clamp apparatus 10.

For example, the clamp arm pairs 14, 16 may in each case be pivotably supported by means of a preferably elongate rotary pin 32, 34 of the clamp carrier 18. In detail, the clamp arms 24, 26, 28, 30 may each have a through-hole, for example, at an end of the respective clamp arm 24, 26, 28, 30 opposite the free ends in each case. The rotary pins 32, 34 may extend through the through-holes. It is possible for sliding bushings to be arranged between the rotary pins 32, 34 and the through-holes.

The rotary pins 32, 34 may extend coaxially relative to a pivot axis of the clamp arm pairs 14, 16 or the clamp arms 24, 26, 28, 30. The rotary pins 32, 34 may extend parallel with a vertical axis of the clamp apparatus 10 or the container 12. The rotary pins 32, 34 may be arranged at opposite sides of the clamp carrier 18. For example, the rotary pin 32 may be arranged at an upper side of the clamp carrier 18. The rotary pin 34 may be arranged at a lower side of the clamp carrier 18.

The first clamp arms 24, 26 may be fitted one above the other on the rotary pin 32. The second clamp arms 28, 30 may be fitted one above the other on the rotary pin 34. The first clamp arms 24, 26 may be secured axially on the rotary pin 32. The second clamp arms 28, 30 may be secured axially on the rotary pin 34. The respective axial securing can be carried out, for example, by means of a screw head of a screw which is screwed into a (for example, central) hole in the rotary pin 32, 34, preferably coaxially relative to the pivot axis of the clamp arm pairs 14, 16 or the clamp arms 24, 26, 28, 30.

Adjacent to the pivotable bearing with respect to the clamp carrier 18, the clamp arm pairs 14, 16 may be reinforced. In detail, a material thickness of the clamp arms 24, 26, 28, 30 may be increased adjacent to the pivotable bearing. The clamp arms 24, 26, 28, 30 may, for example, have reinforcement ribs 36 adjacent to the pivotable bearing. The reinforcement ribs 36 may, for example, be in the form of wall elements at an upper side and/or a lower side of the clamp arms 24, 26, 28, 30. The wall elements may be annular or circumferential structures. The reinforcement ribs 36 may be arranged in the portion of the clamp arms 24, 26, 28, 30 which are opposite the free ends of the clamp arms 24, 26, 28, 30. The reinforcement ribs 36 may taper in the direction towards the free ends of the clamp arms 24, 26, 28, 30.

It is possible for the clamp arms 24 and 26 and 28 and 30, for example, in the central portions thereof (with respect to the respective longitudinal axes) to have stops which face each other. At the stops, the clamp arms, 24 and 26 and 28 and 30 may abut each other in the closure position when they do not retain any container 12.

The clamp arm pairs 14, 16 can be moved by the drive units 20, 22. The drive units 20, 22 can drive the movement of the clamp arms pairs 14, 16. In detail, the first drive unit 20 in order to actuate, for example, to open and/or close, the first clamp arm pair 14 is operationally connected to the first clamp arm pair 14. The second drive unit 22 is in order to actuate, for example, to open and/or close, the second clamp arm pair 16 operationally connected to the second clamp arm pair 16. Preferably, the clamp arm pairs 14, 16 can be pivoted by the drive units 20, 22. In a particularly preferred manner, the drive units 20, 22 can drive the clamp arm pairs 14, 16 in such a manner that they pivot closed in order to hold or receive the container 12 and pivot open in order to release the retained container 12. As mentioned, however, it is also possible for the clamp arm pair 14, 16 to be displaceable rather than pivotable. Accordingly, the drive units 20, 22 may drive the clamp arm pairs 14, 16 in such a manner that they are displaced.

The drive units 20, 22 are preferably pneumatic drive units. Preferably, the drive units 20, 22 are in the form of actuating drives or actuating motors. Preferably, the drive units 20, 22 are linear drive units.

The first drive unit 20 may have a first output element 20.1. The second drive unit 22 may have a second output element 22.1. The first output element 20.1 can move the first clamp arm pair 14. The second output element 22.1 can move the second clamp arm pair 16. Preferably, the output elements 20.1 and 22.1 can be moved or displaced in a linear manner.

The drive units 20, 22 may, for example, be in the form of pneumatic cylinder/piston units. The piston can be received in the cylinder so as to be able to be moved back and forth. The piston may be the output element 20.1, 22.1 of the respective drive unit 20, 22. A supply of compressed air to a piston chamber in the cylinder can move the piston in a first direction, for example, in order to move out of the cylinder. A supply of compressed air to an annular chamber in the cylinder can be moved in a second direction opposite the first direction, for example, in order to move into the cylinder.

The drive units 20, 22 may preferably have a maximum limited travel for the respective output element 20.1, 22.1 in order, for example, to be able to grip a maximum possible container diameter.

The drive units 20, 22 may, for example, be controlled pneumatically. Preferably, the drive units 20, 22 may be able to be controlled independently of each other.

It is possible, for example, for a retention force, an opening time, a closure time and/or an adjustment path of the first clamp arm pair 14 to be able to be adjusted in a variable manner by means of the first drive unit 20 and/or the second clamp arm pair 16 by means of the second drive unit 22. The variable adjustment can preferably be carried out during current operation and/or for example, require no retrofitting.

In order to control the drive units 20, 22, a control unit 37 (only illustrated schematically in FIGS. 1 and 2) may be included. The control unit 37 is preferably a pneumatic control unit.

The control unit 37 can in order to (actuate) control the drive units 20, 22, for example, be pneumatically connected to the drive units 20, 22. In a particularly preferred manner, the pneumatic connection between the control unit 37 and the first drive unit 20 is configured separately or independently of the pneumatic connection between the control unit 37 and the second drive unit 22. For example, the control unit 37 may be pneumatically connected to a piston space and/or an annular space of the first drive unit 20 and to a piston space and/or an annular space of the second drive unit 22.

The control unit 37 is preferably connected to control a plurality of drive units 20, 22 of a plurality of clamp apparatuses 10 of a transport apparatus, for example, a clamp starwheel.

The control unit 37 can operate the first drive unit 20 and/or the second drive unit 22, preferably in different modes. It is possible to switch between the modes during operation or during an operational break. The switching of modes is possible without retrofitting the clamp apparatus 10 or the transport apparatus which includes the clamp apparatus 10 being required.

The different modes may, for example, differ in that a retention force of the respective clamp arm pair 14, 16 which is brought about by the respective drive unit 20, 22, a closure time of the respective clamp arm pair 14, 16 which is brought about by the respective drive unit 20, 22, an opening time of the respective clamp arm pair 14, 16 which is brought about by the respective drive unit 20, 22 and/or an adjustment path of the respective clamp arm pair 14, 16 which is brought about by the respective drive unit 20, 22 is at least partially different in the different modes.

The different modes may, for example, be configured and used to retain different containers 12. For example, the different modes may enable containers 12 with different container weights, different container sizes, different container shapes, different container diameters and/or different container materials, to be able to be reliably received, retained and released by the clamp apparatus 10. It is also possible for the different modes to be used to drive or operate the installation or the transport apparatus which comprises the clamp apparatus 10 differently.

The drive units 20, 22 are preferably constructed in a structurally identical and/or functionally identical manner. Preferably, the first drive unit 20 and the second drive unit 22 are constructed in a substantially mirror-symmetrical manner with respect to the longitudinal centre plane of the clamp apparatus 10 or with respect to a horizontal plane (in the assembled state).

The drive units 20, 22 may be arranged one above the other. The drive units 20, 22 may be carried on the clamp carrier 18. Preferably, the drive units 20, 22 are arranged in a state protected on a rear side facing away from the container 12 of the clamp carrier 18.

It is possible for the drive units 20, 22 to be connected directly or to be operationally connected to the clamp arm pairs 14, 16. Alternatively, the drive units 20, 22 may be connected or be operationally connected to the clamp arm pairs 14, 16, for example, by means of a respective connection device 38, 39. The first connection devices 38 may drivingly connect the first drive unit 20 to the first clamp arm pair 14. The second connection device 39 may drivingly connect the second drive unit 22 to the second clamp arm pair 16.

The connection devices 38, 39 may be arranged between the first clamp arm pair 14 and the second clamp arm pair 16, preferably with respect to a vertical axis of the clamp apparatus 10. In detail, the second connection device 39 may be arranged at least partially on an upper side of the second clamp arm pair 16. The first connection device 38 may be arranged at least partially on a lower side of the first clamp arm pair 14. A respective longitudinal extent direction of the connection device 38, 39 can extend substantially parallel with the longitudinal axes of the clamp arm pairs 14, 16.

The connection devices 38, 39 may be carried by the clamp carrier 18. The connection devices 38, 39 may extend at least partially through the clamp carrier 18, preferably in through-holes which extend from a rear side or a side of the clamp carrier 18 facing away from the container 12 to a front side or a side of the clamp carrier 18 facing the container 12.

The connection devices 38, 39 may preferably be decoupled from each other so that they can move independently of each other. The first connection device 38 can move without the second connection device 39 moving and vice versa.

The first connection device 38 may in a portion between the free ends and the (for example, pivot) bearing of the first clamp arms 24, 26 be connected to the first clamp arms 24, 26, preferably in central portions of the first clamp arms 24, 26 with respect to the respective longitudinal axis. The second connection device 39 may in a portion between the free ends and the (for example, pivot) bearing of the second clamp arms 28, 30 be connected to the second clamp arms 28, 30, preferably in central portions of the second clamp arms 28, 30 with respect to the respective longitudinal axis.

The first connection device 38 may preferably have a transfer element 40, a coupling element 42 and two pivot arms 44, 46. It is possible for the components 40, 42, 44,46 to be at least partially integrated one in the other. The second connection device 39 with a transfer element 50, a coupling element 52 and two pivot arms 54, 56 may be constructed and function in the same manner as the first connection device 38. The following detailed statements relating to the first connection device 38 can consequently accordingly apply mutatis mutandis to the second connection device 39.

The transfer element 40 may be displaceably supported in the clamp carrier 18, preferably in a sliding bushing. The transfer element 40 may be elongate, preferably rod-like. The transfer element 40 may be displaced by the first output element 20.1, preferably parallel with the longitudinal axis of the first clamp arm pair 14. The transfer element 40 may preferably be fitted at the end to the first output element 20.1. The transfer element 40 may carry the coupling element 42, preferably at one end which is opposite the first output element 20.1.

The coupling element 42 can be fitted to the transfer element 40, preferably at the end face. For example, the coupling element 42 can be fitted to the transfer element 40 by means of a screw. If the transfer element 40 is displaced, the coupling element 42 can also be displaced. The coupling element 42 can couple the transfer element 40 to the pivot arms 44, 46.

The pivot arm 44 may connect the clamp arm 24 to the coupling element 42. The pivot arm 44 may be pivotably connected at one end to the coupling element 42, for example, by means of a bolt or a rotary pin. The pivot arm 44 may be pivotably connected at an opposing end to the clamp arm 24, for example, by means of a bolt or a rotary pin.

The pivot arm 46 may connect the clamp arm 26 to the coupling element 42. The pivot arm 46 may be pivotably connected at one end to the coupling element 42, for example, by means of a bolt or a rotary pin. The pivot arm 46 may be pivotably connected at the opposing end to the clamp arm 26, for example, by means of a bolt or a rotary pin.

The pivot arms 44, 46 are preferably V-shaped and/or arranged one above the other (for example, with respect to a vertical axis of the clamp apparatus 10). The pivot arms 44, 46 can preferably be pivoted coaxially with respect to the coupling element 42. For example, however, parallel pivot axes for the pivot arms 44, 46 with respect to the coupling element 42 are also possible. The pivot arms 44, 46 may be arranged with respect to a vertical axis of the clamp apparatus 10 preferably between the coupling element 42 or the transfer element 40 and the first clamp arm pair 14.

A mechanical input by the first output element 20.1 of the first drive unit 20 can bring about a displacement of the transfer element 40 in the direction towards or away from the container 12. A displacement of the transfer element 40 in the direction towards or away from the container 12 can bring about a displacement of the coupling element 42 in the direction towards or away from the container 12. A displacement of the coupling element 42 in the direction towards or away from the container 12 can bring about a displacement of the ends of the pivot arms 44, 46 which are pivotably connected to the coupling element 42 in the direction towards or away from the container 12. A displacement of the ends of the pivot arms 44, 46 which are pivotably connected to the coupling element 42 can bring about a pivoting of the pivot arms 44, 46 at these ends since the pivot arms 44, 46 are supported on the clamp arms 24, 26. The pivoting of the pivot arms 44, 46 brings about a pivoting of the clamp arms 24, 26, for example, a pivoting open or opening of the clamp arms 24, 26 in order to release the container 12 or a pivoting closed or closure of the clamp arms 24, 25 in order to grip the container 12.

The transfer element 40, the coupling element 42, the pivot arms 44, 46 and the clamp arms 24, 26 may preferably together form a toggle lever or a toggle joint.

Preferably, the clamp arm pairs 14, 16, the drive units 20, 22 and the connection devices 38, 39 have no resilient spring elements. However, it is in principle also possible, for example, for the drive units 20, 22 to have a resilient spring element so that the output element 20.1, 22.1 is pretensioned, for example, in the direction towards an opening position or a closure position.

The clamp apparatus 10 may have a securing device 62. The securing device 62 may be constructed to secure the clamp apparatus 10 to a transport apparatus, for example, a transport carousel, for example, by means of a screw connection. The securing device 62 may have at least one positioning element. The positioning element can position the clamp apparatus 10 correctly on the transport apparatus during the securing to the transport apparatus. The positioning element may, for example, be in the form of a positioning pin. The securing device 62 may be secured to the clamp carrier 18, for example, to a rear side, upper side and/or lower side of the clamp carrier 18.

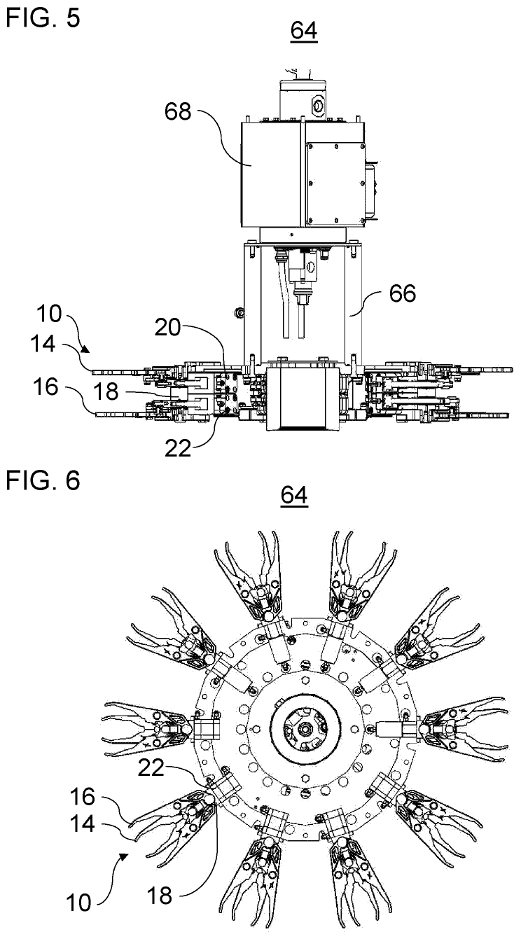

FIGS. 4 to 6 show different views of a transport apparatus 64 with a plurality of clamp apparatuses 10. For the sake of greater clarity, only one clamp apparatus 10, etcetera, is denoted with a reference numeral.

The transport apparatus 64 may preferably be included in a container treatment installation for transporting containers 12. In the container treatment installation, the containers 12 may, for example, be produced, cleaned, checked, filled, closed, labelled, printed and/or packaged. It is possible for the transport apparatus 64 to be arranged, for example, as a star-like inlet member (inlet starwheel) or a star-like outlet member (outlet starwheel) of a container treatment apparatus.

The transport apparatus 64 is preferably configured as a rotatable transport carousel. The clamp apparatuses 10 are arranged, preferably in a uniform manner, around a circumference of the transport apparatus 64. The transport apparatus 64 may be in the form of a so-called clamp(ing) starwheel. As a result of the dual-level nature of the clamp apparatuses 10, the clamp starwheel is in the form of a dual-level clamp starwheel.

The transport apparatus 64 may have a drive unit 66 and a rotary distributor or a rotary transmission leadthrough 68.

By means of the drive unit 66, the transport apparatus 64 and consequently the clamp apparatuses 10 can be moved. Preferably, the drive unit 66 can rotate the transport apparatus 64 and consequently the clamp apparatuses 10 about a vertical centre axis of the transport apparatus 64. The drive unit 66 can depending on the configuration, for example, be arranged at an upper side or a lower side of the transport apparatus 64.

The rotary distributor 68 can be connected to the first drive unit 20 and the second drive unit 22. The rotary distributor 68 may, for example, have a pneumatic interface which enables a pneumatic connection between a rotating portion of the rotary distributor 68 and a fixed portion of the rotary distributor 68. For example, the housing of the rotary distributor 68 may be fixed. A portion of the rotary distributor 68 which is arranged inside the housing may in turn be rotatably supported and also rotate with the rotating transport apparatus 64 during operation.

The rotary distributor 68 may be constructed to enable a sealed transition of at least one fluid between a fixed member and a rotating member. The rotary distributor 68 may be single-flow (singlechannel or single-track) or multi-flow (multi-channel or multi-track). Preferably, the rotary distributor 68 has a (at least one) pneumatic flow or track for compressed air which is or can be connected to the drive units 20, 22. Optionally, the rotary distributor 68 may, for example, have a product or filling material flow or track for a product which is intended to be introduced, that is to say, for example, when the transport apparatus 64 is integrated in a filler.

Depending on the embodiment, the control unit 37 may be arranged in the connection between the rotary distributor 68 and the drive units 20, 22. Alternatively, the control unit 37 may not be connected or interposed between the rotary distributor 68 and the drive units 20, 22. In the illustrated embodiment of FIG. 4, the control unit 37 is in the form of a pneumatic control unit and has, for example, at least one (for example, two) pneumatic valve islands by means of which a supply of compressed air to the drive units 20, 22 (for example, to the piston spaces and/or annular spaces thereof) can be controlled. For example, the at least one valve island is arranged at an upper side of the transport apparatus 64.

The invention is not limited to the preferred embodiments described above. Instead, a large number of variants and modifications which also make use of the notion of the invention and are therefore included within the protective scope are possible. In particular, the invention also claims protection for the subject-matter and the features of the dependent claims regardless of the claims which are referred to. In particular, the individual features of the independent claim 1 are disclosed independently of each other. In addition, the features of the subordinate claims are also disclosed independently of all the features of the independent claim 1 and are, for example, disclosed independently of the features relating to the presence and/or the configuration of the first clamp arm pair, the second clamp arm pair, the first drive unit and/or the second drive unit of the independent claim 1.

### LIST OF REFERENCE NUMERALS

10 Clamp apparatus
12 Container
14 First clamp arm pair
16 Second clamp arm pair
18 Clamp carrier
20 First drive unit
20.1 First output element
22 Second drive unit
22.1 Second output element
24 Clamp arm
26 Clamp arm
28 Clamp arm
30 Clamp arm
32 Rotary pin
34 Rotary pin
36 Reinforcement rib
37 Control unit
38 First connection device
39 Second connection device
40 Transfer element
42 Coupling element
44 Pivot arm
46 Pivot arm
50 Transfer element
52 Coupling element
54 Pivot arm
56 Pivot arm
62 Securing device
64 Transport apparatus
66 Drive unit
68 Rotary distributor

1. A clamp apparatus for retaining a container for a container treatment installation, comprising:
a first clamp arm pair and a second clamp arm pair which are arranged one above the other for the simultaneous retention of the container;
a first drive unit which in order to actuate the first clamp arm pair is operationally connected to the first clamp arm pair; and
a second drive unit which in order to actuate the second clamp arm pair is operationally connected to the second clamp arm pair.

2. The clamp apparatus according to claim 1, wherein at least one of:
the first drive unit and the second drive unit are controlled independently of each other; and
the first clamp arm pair is actuated via the first drive unit and the second clamp arm pair is actuated via the second drive unit independently of each other.

3. The clamp apparatus according to claim 2, wherein the first drive unit and the second drive unit are pneumatically controlled independently of each other.

4. The clamp apparatus according to claim 1, wherein at least one of the first drive unit and the second drive unit includes a pneumatic drive unit.

5. The clamp apparatus according to claim 4, wherein the pneumatic drive unit includes a pneumatic actuator

6. The clamp apparatus according to claim 1, wherein at least one of:
at least one of a retention force, an opening time, a closure time and an adjustment path of the first clamp arm pair via the first drive unit are configured to be adjusted in a variable manner; and
at least one of a retention force, an opening time, a closure time and an adjustment path of the second clamp arm pair via the second drive unit are configured to be adjusted in a variable manner.

7. The clamp apparatus according to claim 6, wherein at least one of:
at least one of the retention force, the opening time, the closure time and the adjustment path of the first clamp arm pair via the first drive unit are configured to be pneumatically adjusted in a variable manner, and
at least one of the retention force, the opening time, the closure time and the adjustment path of the second clamp arm pair via the second drive unit are configured to be pneumatically adjusted in a variable manner.

8. The clamp apparatus according to claim 1, further having a control unit for controlling at least one of the first drive unit and the second drive unit, wherein the control unit is configured to operate at least one of the first drive unit and the second drive unit in different modes.

9. The clamp apparatus according to claim 8, wherein the different modes differ at least partially with respect to at least one of a retention force, an opening time, a closure time and an adjustment path of the respective clamp arm pair.

10. The clamp apparatus according to claim 8, wherein the different modes are configured for retaining different containers, wherein the different containers differ with respect to at least one of a container weight, a container size, a container shape, a container diameter and a container material.

11. The clamp apparatus according claim 1, wherein at least one of the operational connection between the first drive unit and the first clamp arm pair, the operational connection between the second drive unit and the second clamp arm pair, the first drive unit and the second drive unit are formed without a resilient spring element.

12. The clamp apparatus according to claim 1, further having a clamp carrier which carries the first clamp arm pair and the second clamp arm pair in a movable manner.

13. The clamp apparatus of claim 12, wherein at least one of:
the clamp carrier is at least one of substantially block-shaped and elongate, and
the movable manner is displaceable or pivotable at mutually opposing end regions of the clamp carrier.

14. The clamp apparatus according to claim 12, wherein at least one of the first drive unit and the second drive unit is carried by the clamp carrier.

15. The clamp apparatus of claim 14, wherein the at least one of the first drive unit and the second drive unit is carried by the clamp carrier at a rear side of the clamp carrier which is opposite a front side of the clamp carrier facing the container retained by the first clamp arm pair and the second clamp arm pair.

16. The clamp apparatus according to claim 1, wherein at least one of:
the first clamp arm pair has two first clamp arms for abutting the container and which are configured to be moved in opposing directions relative to each other; and
the second clamp arm pair has two second clamp arms for abutting the container and which are configured to be moved in opposing directions relative to each other.

17. The claim apparatus of claim 16, wherein at least one of:
the two first clamp arms are coupled to each other,
the two first clamp arms are moved via pivot or displacement in the opposing directions relative to each other,
the two second clamp arms are coupled to each other, and
the two second clamp arms are moved via pivot or displacement in the opposing directions relative to each other.

18. The clamp apparatus according to claim 1, further having at least one of:
two first pivot arms which are arranged in a V-shaped manner and which are configured to be displaced back and forth in response to a mechanical input via the first drive unit and which are each pivotably fitted to one clamp arm of the first clamp arm pair; and
two second pivot arms which are arranged in a V-shaped manner and which are configured to be displaced back and forth in response to a mechanical input via the second drive unit and which are each pivotably fitted to one clamp arm of the second clamp arm pair.

19. The clamp apparatus according to claim 18, wherein at least one of:
the two first pivot arms are fitted so as to be able to be pivoted to a displaceable first transfer element which is displaceably supported in a clamp carrier of the clamp apparatus, is rod-like and configured to be displaced by the first drive unit; and
the two second pivot arms are fitted so as to be able to be pivoted to a displaceable second transfer element which is displaceably supported in a clamp carrier of the clamp apparatus, is rod-like and configured to be displaced by the second drive unit.

20. The clamp apparatus according to claim 19, wherein at least one of:
the two first pivot arms are fitted so as to be able to be coaxially pivoted to the displaceable first transfer element, and
the two second pivot arms are fitted so as to be able to be coaxially pivoted to the displaceable second transfer element.

21. A transport apparatus for containers for a container treatment installation, comprising:
at least one clamp apparatus according to claim 1.

22. The transport apparatus according to claim 21, further having:
a rotary distributor which is connected to at least one of the first drive unit and the second drive unit, or
a rotary distributor which is pneumatically connected to at least one of the first drive unit and the second drive unit.

23. The transport apparatus according to claim 21, wherein the transport apparatus is a rotatable clamp starwheel.
